(19) United States
(12) Patent Application Publication
(10) Pub. No.: US 2011/0176676 A1
(43) Pub. Date: Jul. 21, 2011

(54) METHOD, APPARATUS AND COMPUTER PROGRAM PRODUCT FOR EFFICIENT ELLIPTIC CURVE CRYPTOGRAPHY

(75) Inventor: Kaisa Nyberg, Helsinki (FI)

(73) Assignee: NOKIA CORPORATION, Espoo (FI)

(21) Appl. No.: 13/121,345

(22) PCT Filed: Sep. 23, 2009
(86) PCT No.: PCT/FI2009/050755

§ 371 Date: Mar. 28, 2011

Related U.S. Application Data
(60) Provisional application No. 61/100,926, filed on Sep. 29, 2008.

(51) Int. Cl. H04L 9/00

(52) U.S. Cl. 380/44

(57) ABSTRACT

A method, apparatus and computer program product are provided to more efficiently perform aspects of elliptic curve cryptography such as by more efficiently multiplying an integer k by a point P on an elliptic curve by decomposing the integer into integers k1 and k2. In this regard, respective bounds for k1 and k2 may be determined (100, 102) and, subject to the respective bounds, k1 and k2 may then be determined (114, 116) such that the product of k and the point P on the elliptic curve may be determined based upon k1 and k2 without requiring the point P to be multiplied by k.

### CROSS REFERENCE TO RELATED APPLICATION

This application claims the benefit of U.S. Provisional Application No. 61/100,926, filed Sep. 29, 2008, the contents of which are incorporated herein in their entirety.

### TECHNOLOGICAL FIELD

Embodiments of the present invention relate generally to public key cryptography and, more particularly, to methods, apparatus and computer programs products for efficiently implementing elliptic curve cryptography.

### BACKGROUND

Various techniques have been employed to increase the security associated with the communication of messages and to correspondingly decrease the risk that unintended recipients can comprehend and make use of the messages. Accordingly, a variety of cryptographic techniques have been developed such that messages between two or more parties may be encrypted. While the authorized parties can decrypt the messages and utilize the messages for their intended purpose, the use of encryption decreases the risk that untended recipients can similarly make use of the messages.

One cryptographic technique relies upon public key cryptography. In public key cryptography, a first party has a pair of cryptographic keys—a public key and private key. The private key remains a secret to the first party, but the public key may be distributed to other parties. Thus, messages received by the first party that have been encrypted with the public key of the first party can only by decrypted utilizing the corresponding private key. Since the first party will be the only party having the private key, the first party is the only one that can decrypt the message. While the public and private keys are related mathematically, the private key cannot, as a practical matter, be derived from the public key.

One approach to public key cryptography is elliptic curve cryptography. Elliptic curve cryptography is based on the algebraic structure of elliptic curves over finite fields. Indeed, elliptic curve cryptography is becoming an increasingly common algebraic setting for public key cryptography due, for example, to the relatively short parameter and key lengths. For example, the Bluetooth™ wireless protocol has a pairing method that uses elliptic curve cryptography over a prime field.

While elliptic curve cryptography offers various advantages including advantages relating to relatively short parameter and key lengths, elliptic curve cryptography may suffer from having field operations that are more complicated and slower than are desired. As such, a variety of techniques have been developed in an effort to improve the performance of elliptic curve cryptography. In this regard, elliptic curve cryptography utilizes the integer multiples of points on an elliptic curve and, as such various representations of the integer have been developed in order to increase the computational speed. For example, the binary representation of the integer may be utilized in order to reduce the relatively large multiplication task to a series of point doublings and multiplication. Alternatively, curve endomorphism may be utilized. In this regard, the efficiency offered by curve endomorphism can be appreciated by considering E to be an elliptic curve over Fq with P being a point on the curve that generates a relatively large subgroup of order n on E. Additionally, Φ can be an endomorphism over Fq and λ can be a root of the characteristic polynomial of Φ modulo n. As such the multiplication by λ of the point P can by computed as Φ(P). In many cases, Φ(P) can be computed relatively rapidly. Then, if any positive integer k less than n can be decomposed in the form as k=k1+k2·λ(mod n) wherein k1 and k2 are shorter than k, then kP can be efficiently computed as kP=k1+k2·Φ(P), wherein “·” denotes integer multiplication. If k1 and k2 are about the same size, then various methods for simultaneous scalar multiplication can be efficiently used.

In order to increase the efficiency of elliptic curve cryptography, techniques have been developed for computing, given a positive integer n and positive integers λ and k less than n, a decomposition of k=k1+k2λ. In this regard, the values k1 and k2 can be determined utilizing the LLL algorithm or, as described by the European Patent Application to Robert Gallant et al. bearing Publication No. EP 1 141 820, by first computing two relatively short vectors v1 and v2 using the extended Euclidean algorithm. The resulting system of linear equations is then solved by linear algebra to determine fractions q1 and q2, which are then rounded to the nearest integers, designated, for example, as b1 and b2, respectively. Then the two components of the vector (k,0)−(b1v1+b2v2) may be computed. k1 may be obtained as the first component and k2 may be obtained as the second component of this vector.

While these techniques permit the determination of k1 and k2 into which the positive integer k is decomposed, these techniques do not provide any bounds upon the size of k1 and k2. For efficient simultaneous scalar multiplication, however, it is desired that the decomposition of k in terms of k1 and k2 be balanced, meaning that k1 and k2 are of about equal size. By failing to have bounds on the size of k1 and k2, such prior techniques may fail to operate in the most optimal manner. As such, it would be desirable to provide an improved elliptic curve cryptographic technique in which the sizes of k1 and k2 are known to be relatively equally small for given n and λ. Also while the foregoing techniques allow efficient implementation on some computation environments, they require division of integers and rounding fractions, which may not be readily available in every computation platform. As such, it would also be desirable to provide an improved elliptic curve cryptographic technique which is configured to be supported by a relatively wide range of computation platforms.

### BRIEF SUMMARY

A method, apparatus and computer program product are therefore provided in order to more efficiently perform aspects of elliptic curve cryptography. In particular, methods, apparatus and computer program products are provided that may more efficiently multiply an integer k by a point P on an elliptic curve by decomposing the integer k into integers k1 and k2. In accordance with a method of one embodiment, respective bounds for k1 and k2 are then determined. Subject to the respective bounds, k1 and k2 may then be determined such that the product of k and the point P on the elliptic curve may be determined based upon k1 and k2 without requiring the point P to be multiplied by k. In order to determine the respective bounds, an extended Euclidean algorithm may be run for a number of points n on the elliptic curve and a multiplier λ to generate sequences of quotients and remainders such that the m^{th} remainder is identified to bound k1 based upon the relationship of the m^{th} remainder to n. Additionally, a sequence of integers t may be determined based upon the sequence of quotients such that the bound for k2 may be defined based upon a relationship of at least two of the integers t to n.

According to another embodiment of the present invention, an apparatus is provided that includes a processor that may be configured to more efficiently multiply an integer k by a point P on an elliptic curve by decomposing the integer k into integers k1 and k2. In accordance with one embodiment, the processor may also be configured to determine respective bounds for k1 and k2. Subject to the respective bounds, the processor may be configured to determine k1 and k2 such that the product of k and the point P on the elliptic curve may be determined based upon k1 and k2 without requiring the point P to be multiplied by k. In order to determine the respective bounds, the processor may be configured to run an extended Euclidean algorithm for a number of points n on the elliptic curve and a multiplier λ to generate sequences of quotients and remainders such that the m^{th} remainder is identified to bound k1 based upon the relationship of the m^{th} remainder to n. Additionally, the processor may be configured to determine a sequence of integers t based upon the sequence of quotients such that the bound for k2 may be defined based upon a relationship of at least two of the integers t to n.

According to yet another embodiment of the present invention, a computer program product is provided for more efficiently multiplying an integer k by a point P on an elliptic curve. The computer program product includes a computer-readable storage medium and a plurality of computer-readable instructions stored upon the computer-readable storage medium. The computer-readable instructions may include first computer-readable instructions for decomposing the integer k into integers k1 and k2, second computer-readable instructions for determining bounds for k1 and k2 and third computer-readable instructions for determining k1 and k2, subject to the respective bounds, such that the product of k and the point P on the elliptic curve may be determined based upon k1 and k2 without requiring the point P to be multiplied by k. In order to determine the respective bounds, the second computer-readable instructions may be configured to run an extended Euclidean algorithm for a number of points n on the elliptic curve and a multiplier k to generate sequences of quotients and remainders such that the m^{th} remainder is identified to bound k1 based upon the relationship of the m^{th} remainder to n. Additionally, the second computer-readable instructions may be configured to determine a sequence of integers t based upon the sequence of quotients such that the bound for k2 may be defined based upon a relationship of at least two of the integers t to n.

### BRIEF DESCRIPTION OF THE DRAWINGS

Having thus described some embodiments of the invention in general terms, reference will now be made to the accompanying drawings, which are not necessarily drawn to scale, and wherein:

FIG. 1 is a block diagram of a system for employing elliptic curve cryptography according to one embodiment of the present invention;

FIG. 2 is a schematic block diagram of a mobile terminal according to one embodiment to the present invention; and

FIG. 3 is a flow chart of the operations performed in accordance with one embodiment to the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

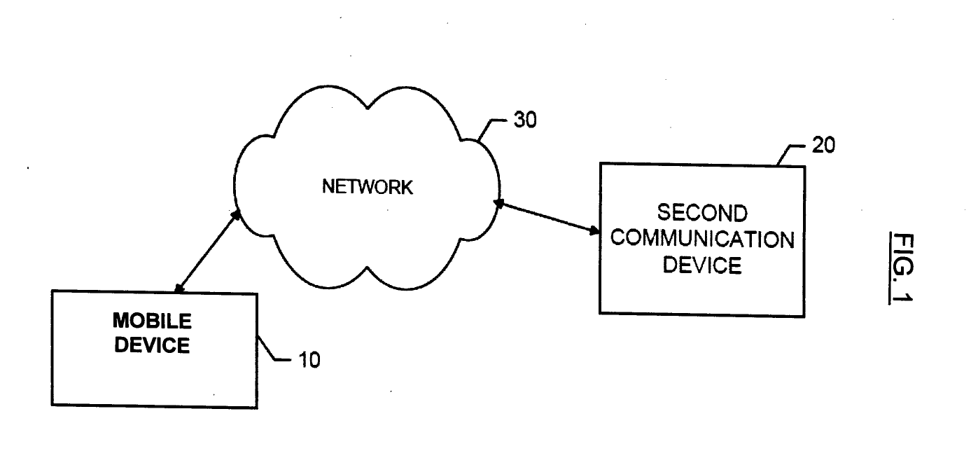

FIG. 1 illustrates a generic system diagram in which a device such as a mobile terminal 10, which may benefit from embodiments of the present invention, is shown in an exemplary communication environment. As shown in FIG. 1, an embodiment of a system in accordance with an example embodiment of the present invention may include a first communication device (e.g., mobile terminal 10) and a second communication device 20 capable of communication with each other via a network 30.

The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like.

One or more communication terminals such as the mobile terminal 10 and the second communication device 20 may be in communication with each other via the network 30 and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing elements (e.g., personal computers, server computers or the like) may be coupled to the mobile terminal 10 and the second communication device 20 via the network 30. By directly or indirectly connecting the mobile terminal 10 and the second communication device 20 and other devices to the network 30, the mobile terminal 10 and the second communication device 20 may be enabled to communicate with the other devices or each other, for example, according to numerous communication protocols including Hypertext Transfer Protocol (HTTP) and/or the like, to thereby carry out various communication or other functions of the mobile terminal 10 and the second communication device 20, respectively.

Furthermore, although not shown in FIG. 1, the mobile terminal 10 and the second communication device 20 may communicate in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, ultra-wide band (UWB), Wibree techniques and/or the like. As such, the mobile terminal 10 and the second communication device 20 may be enabled to communicate with the network 30 and each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

In example embodiments, either of the first communication device and the second communication device 20 may be mobile or fixed communication devices. Thus, for example, the mobile terminal 10 and the second communication device 20 could be, or be substituted by, any of personal computers (PCs), personal digital assistants (PDAs), wireless telephones, desktop computers, laptop computers, mobile computers, cameras, video recorders, audio/video players, positioning devices, game devices, television devices, radio devices, or various other like devices or combinations thereof.

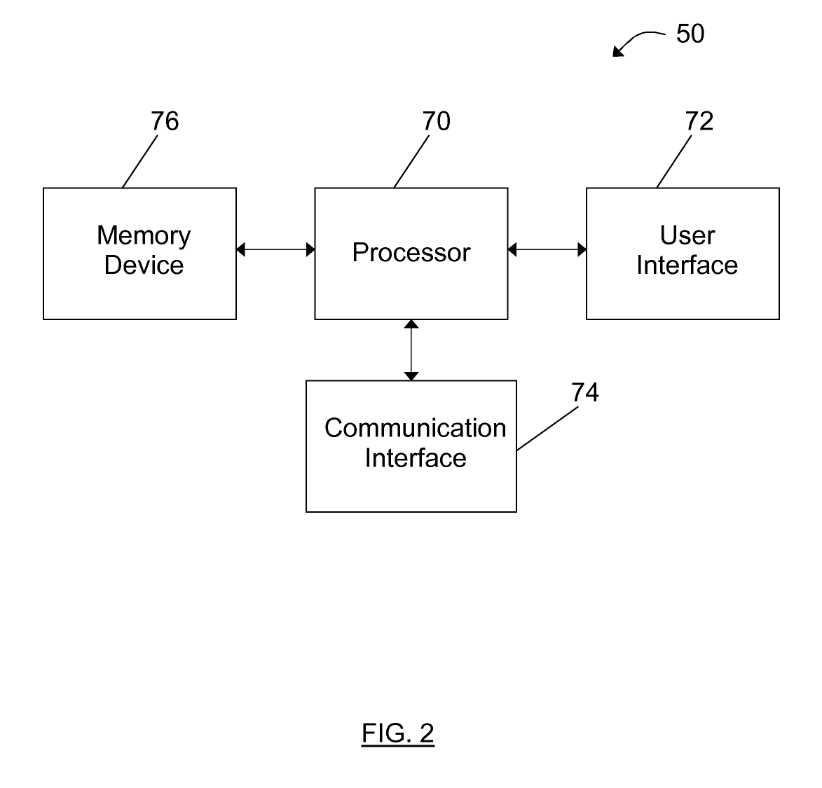

FIG. 2 illustrates a schematic block diagram of an apparatus for facilitating elliptic curve cryptography according to an exemplary embodiment of the present invention. The apparatus 50 of FIG. 2 may be employed, for example, on or as a communication device (e.g., the mobile terminal 10 and/or the second communication device 20) or a variety of other devices, both mobile and fixed (such as, for example, any of the devices listed above). Alternatively, embodiments may be employed on a combination of devices. Accordingly, some embodiments of the present invention may be embodied wholly at a single device (e.g., the mobile terminal 10) or by devices in a client/server or distributed computing relationship. Furthermore, it should be noted that the devices or elements described below may not be mandatory and thus some may be omitted in certain embodiments.

As shown, the apparatus 50 may include or otherwise be in communication with a processor 70, a user interface 72, a communication interface 74 and a memory device 76. The memory device 76 may include, for example, volatile and/or non-volatile memory. The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content.

The processor 70 may be embodied in a number of different ways. For example, the processor 70 may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 70 may be configured to execute instructions stored in the memory device 76 or otherwise accessible to the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications via Bluetooth signaling protocol or with a wireless communication network. In fixed environments, the communication interface 74 may alternatively or also support wired communication. As such, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, a microphone, a speaker, or other input/output mechanisms. In an exemplary embodiment in which the apparatus is embodied as a server or some other network devices, the user interface 72 may be limited, or eliminated. However, in an embodiment in which the apparatus is embodied as a communication device (e.g., the mobile terminal 10), the user interface 72 may include, among other devices or elements, any or all of a speaker, a microphone, a display, and a keyboard or the like.

Referring now to FIG. 1, the system of one embodiment may be configured to support communications between the mobile terminal 10 and the second communications device 20 that are encrypted in accordance with a public key cryptographic technique. More particularly, the system of one embodiment may be configured to support encryption of the communications between the mobile terminal 10 and the second communications device 20 (or between any other communications devices) in accordance with elliptic curve cryptography. For example, the mobile terminal 10 and the second communications device 20 may be configured to communicate with one another via the Bluetooth™ signaling protocol and, as such, mobile terminal 10 and/or the second communications device 20 may employ elliptic curve cryptography in order to secure the Bluetooth™ communications therebetween. As noted above, however, the mobile terminal 10 and the second communications device 20 may communicate via a wide variety of other networks and signaling protocols, if so desired.

As described below and in accordance with one embodiment, the apparatus 50 and, in particular, the processor 70 may be configured to support elliptic curve cryptography by determining the values of k1 and k2 into which the integer multiplier k may be decomposed in such a manner that bounds on the sizes of the integers k1 and k2 may also be determined. In accordance with elliptic curve cryptography, a point on an elliptic curve may be multiplied by a previously unknown integer multiplier k. In order to increase the speed at which this multiplication is performed, the multiplier λ may be provided and k may be decomposed into smaller integers k1 and k2 such that the multiplication of the point on the elliptic curve by the integer multiplier k can be equivalently and more quickly computed by combining the results of two multiplication operations, namely, the multiplication of point p by k1 and the multiplication of point p by the product of λ and k2.

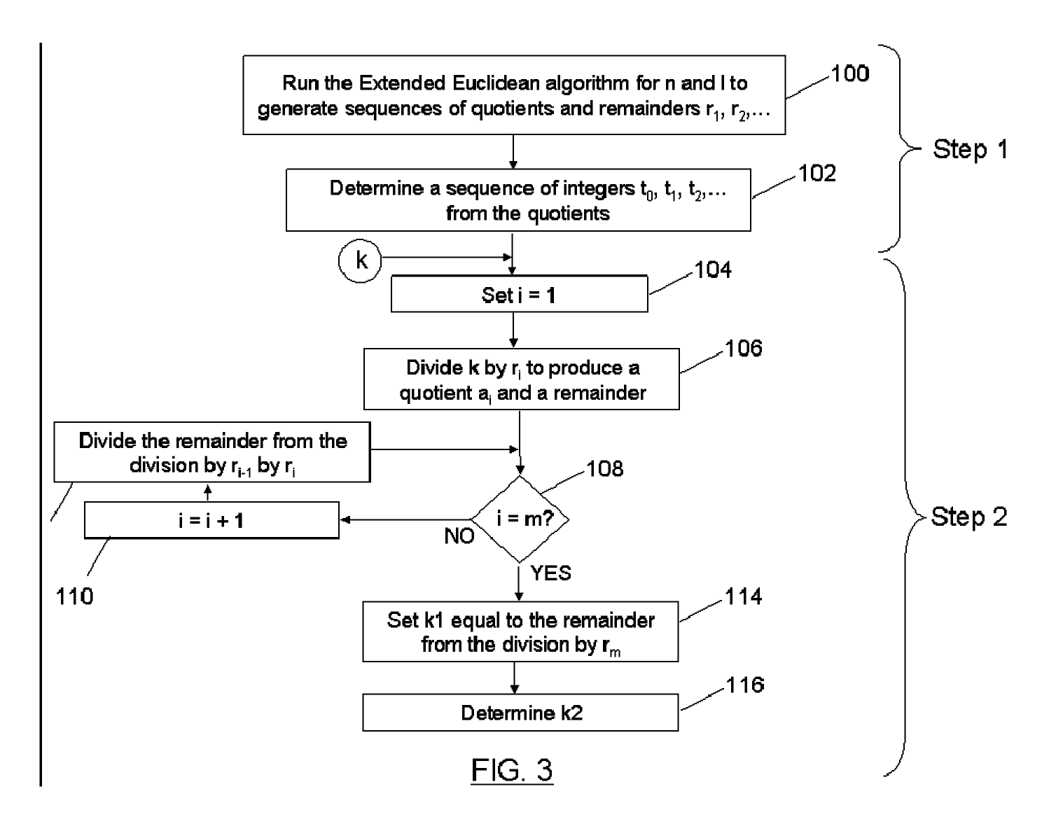

In order to determine the values k1 and k2 as well as their respective bounds, the apparatus 50 and, more typically, the processor 70 of one embodiment may perform the operations set forth in FIG. 3. As shown in FIG. 3, the operations may be generally divided into a first step and a second step. If desired, the first step may be determined in advance of the encryption operation and may be determined once for all future unknown values k. As such, the first step is not dependent upon the value of k. The apparatus 50 may perform the operations of step 1 and then store the results, such as in memory device 76, in order to expedite the subsequent processing. Alternatively, the apparatus 50 can perform the operations of step 1 in line and immediately preceding the operations of step 2 so as to avoid storing the results.

In the first step, λ and n may be provided whereby 0<λ<n. As noted above, n represents the number of points on the elliptic curve and λ is the solution modulo n to a characteristic polynomial of an endomorphism which acts as multiplication by λ on an elliptic curve. As shown in operation 100, the extended Euclidean algorithm may then be run for the integers n and λ in order to find their greatest common divisor. The extended Euclidean algorithm may produce a sequence of quotients and a corresponding sequence of remainders by initially dividing n by λ to produce a quotient and a remainder and then repeatedly dividing the divisor from the prior iteration by the remainder from the prior iteration. As a result of this repeated division, a sequence of positive quotients q₁, q₂, . . . qᵣₘ are generated. In addition, a decreasing sequence of positive remainders r₁, r₂ rₙ₊₁, where r₀=n and r₁=λ are generated as follows

rᵢ₋₁=qᵢrᵢ+rᵢ₊₁, i=1, . . . m.

wherein m is an arbitrary fixed positive integer. Additionally, as shown in operation 102, a sequence of integers tᵢ wherein i=1, 2, . . . n+1 is generated as follows:

tᵢ₋₁=tᵢ₋₁−qᵢtᵢ, and

rᵢ≡tᵢλ(mod n), for all i=1, . . . ,m.

As such, t₀=0, t₁=1, and tᵢ<0, for i even, and tᵢ>0, for i odd.

Based upon these sequences, the number of points on the elliptic curve n can be expressed in a number of different manners. For example, n=|t₂|·r₁+|·r₂, n=|t₃|·r₂+|t₂|·r₃, and n=|t₄|·r₃+|t₃|·r₄, where |t| denotes the absolute value of integer t, and more generally, for any fixed positive integer m it holds that n=|tₘ₊₁|·rₘ+|tₘ|·rₘ₊₁ The sequence of remainders is then reviewed in order to determine two sequential values, such as rₘ and rₘ₊₁ which are both close to the square root of n. The expression for n that relies upon these two sequential values in the sequence of remainders which are close to the square root of n is then determined, that is, n=|tₘ₊₁|·rₘ+|tₘ|·rₘ₊₁. In the foregoing equation, tₘ and tₘ₊₁ are also sequential values from the sequence of integers tᵢ such that tₘ and tₘ₊₁ are also close in value to the square root of n. In one embodiment, the various possibilities for rₘ, rₘ₊₁, tₘ and tₘ₊₁ may be considered with those values selected that allow all of these conditions (rₘ, rₘ₊₁ and the sum of tₘ and tₘ₊₁ to be close to the square root of n) to be as close to being satisfied as possible.

Regardless of the value of the previously unknown integer k, the results of this first step provide bounds for the two integers k1 and k2 into which k may be decomposed. In this regard, k1 is a positive integer that is less than rₘ, while k2 is an integer between −|tₘ|−|tₘ₊₁ and |tₘ+|tₘ₊₁|. As a result, the largest possible values of k1 and |k2| are close to the square root of n. Additionally, k1 and |k2| may also have about the same value, that is both k1 and |k2| may be close to the square root of n.

Thereafter, once k is provided such that 0<k<n, the apparatus 50 and, more typically, the processor 70 repeatedly divides k by the sequence of remainders. In this regard, k is initially divided by r₁. The remainder from this division is then divided by r₂. The remainder from this second division is then divided by r₃. This process is repeated at least until rₘ is employed as the divisor. See operations 104, 106, 108, 110 and 112. The remainder from the division by rₘ is then taken as k1. See operation 114. As such, k1 is nonnegative and necessarily less than rₘ.

The apparatus 50 and, more particularly, the processor 70 are also configured to determine k2 as shown at operation 116. k2 can be determined in various manners including, for example, one technique which makes use of the quotients from the subsequent divisions. In this regard, a₁ is defined to be the quotient when k is divided by r₁. Likewise, a₂ is defined to be the quotient when the remainder from the first division, that is, the division in which r₁ is the divisor, is divided by r₂. This process is repeated for r=1, 2 . . . m to thereby define quotients a₁, a₂, . . . aₘ, respectively, whereby aₘ is the quotient from the division operation in which rₘ is the divisor. As such, k2 may be determined as a sum of a1·t1+a2·t2+a3·t3+ . . . +aₘ·tₘ. As will be noted, the absolute value of k2 is therefore always less than the bound determined in step 1 of |tₘ|+|tₘ₊₁|.

Alternatively, k2 may be determined by subtracting k1 from k and then multiplying the result by the inverse of λ modulo n. In this regard, the inverse of λ may be determined by running the extended Euclidean algorithm with the integers n and λ until the remainder is equal to 1 with the inverse of λ then equaling the corresponding value from the sequence of t values, that is, the t value that corresponds to the remainder being equal to 1.

Based upon the values of k1 and k2, the multiplication of a point P on an elliptic curve by k can be equivalently and more efficiently computed by multiplication of the point on the elliptic curve by k1 added to the multiplication of the point on the curve by λ multiplied by k2, that is, kP=k1P+(k2·λ)P. Based upon the multiplication of the point on the elliptic curve by k, messages, such as messages transmitted between mobile terminal 10 and the second communications device 20, can be subjected to elliptic curve cryptography in order to provide the desired security.

As described above, FIG. 3 is a flowchart of a system, method and program product according to some exemplary embodiments of the invention. It will be understood that each block or step of the flowchart, and combinations of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal or other apparatus employing embodiments of the present invention and executed by a processor in the mobile terminal or other apparatus. As will be appreciated, any such computer program instructions may be loaded onto a computer or other programmable apparatus (e.g., hardware) to produce a machine, such that the instructions which execute on the computer (e.g., via a processor) or other programmable apparatus create means for implementing the functions specified in the flowchart block(s) or step(s). These computer program instructions may also be stored in a computer-readable memory that can direct a computer (e.g., the processor or another computing device) or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In an exemplary embodiment, an apparatus for performing the method of FIG. 3 above may comprise a processor (e.g., the processor 70) configured to perform some or each of the operations (100-116) described above. The processor may, for example, be configured to perform the operations (100-116) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 100-116 may comprise, for example, the processor 70 and/or an algorithm executed by the processor for bounding and determining k1 and k2 described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1.-20. (canceled)

21. An apparatus comprising at least one processor and at least one memory including computer program code, the at least one memory and the computer program code configured to, with the processor, cause the apparatus to at least perform the following:
decompose an integer k into integers k1 and k2;
determine respective bounds for the integers k1 and k2; and
determine the integers k1 and k2 subject to the respective bounds such that a product of the integer k and a point P on an elliptic curve is determinable based upon the integers k1 and k2.

22. An apparatus according to claim 21 wherein the computer program code is further configured to cause the apparatus to determine the product of the integer k and the point P on the elliptic curve by summing a product of the integer k1 and the point P and a product of the point P, the integer k2 and a multiplier λ.

23. An apparatus according to claim 21 wherein the computer program code is further configured to cause the apparatus to determine respective bounds for the integers k1 and k2 by applying an extended Euclidean algorithm for a number of points n on an elliptic curve and a multiplier λ to generate sequences of quotients and remainders r₁, r₂, . . . rₘ, rₘ₊₁, . . . and by determining the rₘ remainder to bound the integer k1 based upon a relationship of the rₘ remainder to n.

24. An apparatus according to claim 23 wherein the computer program code is further configured to cause the apparatus to determine respective bounds for the integers k1 and k2 by a determination of a sequence of integers t₁, t₂, . . . based upon the sequence of quotients and by a definition of the bound for the integer k2 based upon a relationship of at least two of the integers t to n.

25. An apparatus according to claim 23 wherein the computer program code is further configured to cause the apparatus to determine the integer k1 by:
divide k by r₁ to produce a quotient a₁ and a reminder;
for each i=2, 3, . . . m, divide the remainder from a prior division by rᵢ₋₁ by rᵢ to produce a quotient aᵢ and a remainder; and
define the integer k1 to equal the remainder from the prior division by rₘ.

26. An apparatus according to claim 25 wherein the computer program code is further configured to cause the apparatus to determine the integer k2 by:
determine a sequence of integers t₁, t₂, . . . based upon the sequence of quotients; and
define the integer k2 to be a sum of a₁t₁+a₂t₂+ . . . +aₘtₘ.

27. An apparatus according to claim 23 wherein the computer program code is further configured to cause the apparatus to determine the integer k2 by determine a result of reduce k by k1 and then multiply the result by an inverse of λ modulo n.

28. A method comprising:
decomposing an integer k into integers k1 and k2;
determining respective bounds for the integers k1 and k2; and
determining, via a processor, the integers k1 and k2 subject to the respective bounds such that a product of the integer k and a point P on an elliptic curve is determinable based upon the integers k1 and k2.

29. A method according to claim 28 further comprising determining the product of the integer k and the point P on the elliptic curve by summing a product of the integer k1 and the point P and a product of the point P, the integer k2 and a multiplier λ.

30. A method according to claim 28 wherein determining respective bounds for the integers k1 and k2 comprises:
applying an extended Euclidean algorithm for a number of points n on an elliptic curve and a multiplier λ to generate sequences of quotients and remainders r₁, r₂, . . . rₘ, rₘ₊₁, . . . ; and
determining the rₘ remainder to bound the integer k1 based upon a relationship of the rₘ remainder to n.

31. A method according to claim 30 wherein determining respective bounds for the integers k1 and k2 comprises:
determining a sequence of integers t₁, t₂, . . . based upon the sequence of quotients; and
defining the bound for the integer k2 based upon a relationship of at least two of the integers t to n.

32. A method according to claim 30 wherein determining the integer k1 comprises:
dividing k by r₁ to produce a quotient a₁ and a reminder;
for each i=2, 3, . . . m, dividing the remainder from a prior division by rᵢ₋₁ by rᵢ to produce a quotient aᵢ and a remainder; and
defining the integer k1 to equal the remainder from the prior division by rₘ.

33. A method according to claim 32 wherein determining the integer k2 comprises:
determining a sequence of integers t₁, t₂, . . . based upon the sequence of quotients; and
defining the integer k2 to be a sum of a₁t₁+a₂t₂+ . . . +aₘtₘ.

34. A method according to claim 30 wherein determining the integer k2 comprises determining a result of reducing k by k1 and then multiplying the result by an inverse of λ modulo n.

35. A computer program product comprising a computer-readable storage medium bearing computer program code embodied therein for use with a computer, the computer program code comprising:
code configured to decompose an integer k into integers k1 and k2;
code configured to determine respective bounds for the integers k1 and k2; and
code configured to determine the integers k1 and k2 subject to the respective bounds such that a product of the integer k and a point P on an elliptic curve is determinable based upon the integers k1 and k2.

36. A computer program product according to claim 35 wherein the computer program code further comprises code configured to determine the product of the integer k and the point P on the elliptic curve by summing a product of the integer k1 and the point P and a product of the point P, the integer k2 and a multiplier λ.

37. A computer program product according to claim 35 wherein the code configured to determine respective bounds for the integers k1 and k2 further comprises:
code configured to apply an extended Euclidean algorithm for a number of points n on an elliptic curve and a multiplier λ to generate sequences of quotients and remainders r₁, r₂, . . . rₘ, rₘ₊₁, . . . ; and
code configured to determine the rₘ remainder to bound the integer k1 based upon a relationship of the rₘ remainder to n.

38. A computer program product according to claim 37 wherein the code configured to determine respective bounds for the integers k1 and k2 further comprises:
code configured to determine a sequence of integers t₁, t₂, . . . based upon the sequence of quotients; and
code configured to define the bound for the integer k2 based upon a relationship of at least two of the integers t to n.

39. A computer program product according to claim 37 wherein the code configured to determine the integer k1 further comprises:
code configured to divide k by r₁ to produce a quotient a₁ and a reminder; for each i=2, 3, . . . m, code configured to divide the remainder from a prior division by rᵢ₋₁ by rᵢ to produce a quotient aᵢ and a remainder; and
code configured to define the integer k1 to equal the remainder from the prior division by rₘ.

40. A computer program product according to claim 39 wherein the code configured to determine the integer k2 further comprises:
code configured to determine a sequence of integers t₁, t₂, . . . based upon the sequence of quotients; and
code configured to define the integer k2 to be a sum of a₁t₁+a₂t₂+ . . . +aₘtₘ.
